(19) United States
(12) Patent Application Publication
(10) Pub. No.: US 2007/0209172 A1
(43) Pub. Date: Sep. 13, 2007

(54) Keepsake niche

(76) Inventor: Andrew Krawczyk, Toronto (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/372,102

(22) Filed: Mar. 10, 2006

(51) Int. Cl. A61G 17/00

(52) U.S. Cl. 27/35

(57) ABSTRACT

A keepsake niche housing for storing a number of containers for partial cremation remains, the housing including: a frame having a number of compartments, each compartment having containment walls and an access opening, a shutter mounting surface disposed adjacent each access opening; and a number of removable shutters each adapted for individual mounting on each shutter mounting surface over each opening.

### TECHNICAL FIELD

The invention relates to a keepsake niche housing for storing a number of containers for partial cremation remains, in a mausoleum or cemetery monument structure for example.

### BACKGROUND OF THE ART

Cremation of the body is increasingly the choice of many persons and the remains are generally either scattered according to the wishes expressed by the deceased or are stored in urns or other containers in a memorial fashion. Cemeteries and mausoleums have buildings or outdoor structures with wall or ground mounted niches into which remains are stored with a plaque or cover plate showing memorial indicia of the deceased.

In the case of scattering of cremation remains, many jurisdictions have legal restrictions on this practice in public places and cemeteries have responded by setting aside areas dedicated to this practice. However, when ashes are scattered many of the relatives and friends of the deceased desire to preserve some memorial in a permanent and secure manner.

This desire has led to the practice of reserving a portion of the cremation remains in a miniature urn or small container commonly referred to as a “keepsake”. There has arisen a need for respectful, dignified and secure storage of cremation remains with a memorial, and in particular the storage of miniature containers of partial cremation remains in a memorial fashion within a cemetery or mausoleum.

Features that distinguish the present invention from the background art will be apparent from review of the disclosure, drawings and description of the invention presented below.

### DISCLOSURE OF THE INVENTION

The invention provides a keepsake niche housing for storing a number of containers for partial cremation remains, the housing including: a frame having a number of compartments, each compartment having containment walls and an access opening, a shutter mounting surface disposed adjacent each access opening; and a number of removable shutters each adapted for individual mounting on each shutter mounting surface over each opening.

### DESCRIPTION OF THE DRAWINGS

In order that the invention may be readily understood, one embodiment of the invention is illustrated by way of example in the accompanying drawings.

FIG. 1 is an isometric view of a rectangular keepsake niche housing with rows and columns of identical cubic compartments.

FIG. 2 is a side view of divider plates that interlock together at right angles to form the interior walls defining the compartments in FIG. 1.

FIG. 3 is a plan view of the housing with an exterior tray fitted with interior divider plates to form compartments.

FIG. 4 is a plan view of the housing with a cover plate defining openings to access each compartment, a planar surface for mounting shutters and apertures to receive fasteners to secure the shutters.

FIG. 5 is a partial sectional elevation view through two compartments showing two miniature urns in cubic compartments with shutters mounted to the cover plate with screw fasteners.

Further details of the invention and its advantages will be apparent from the detailed description included below.

### DETAILED DESCRIPTION OF PREFERRED EMBODIMENTS

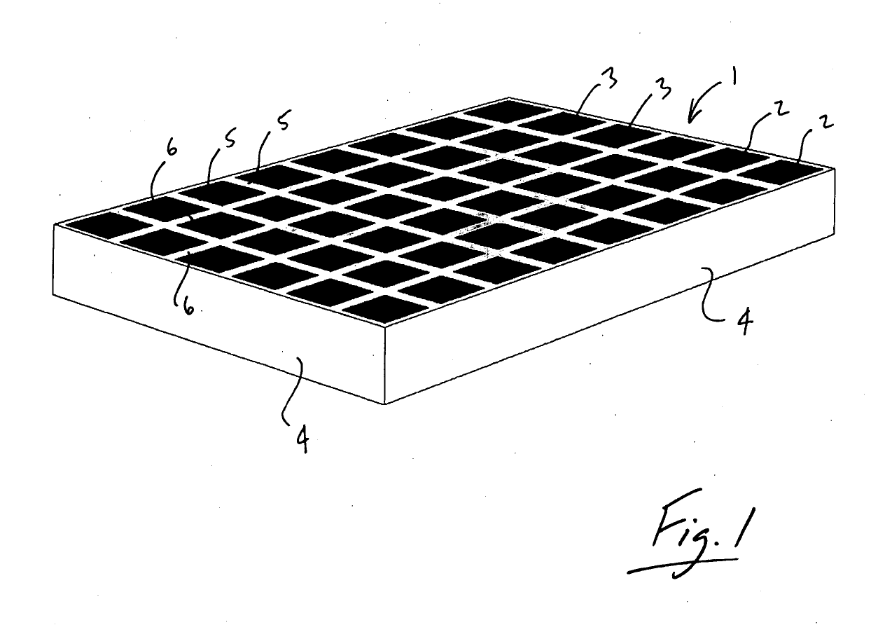

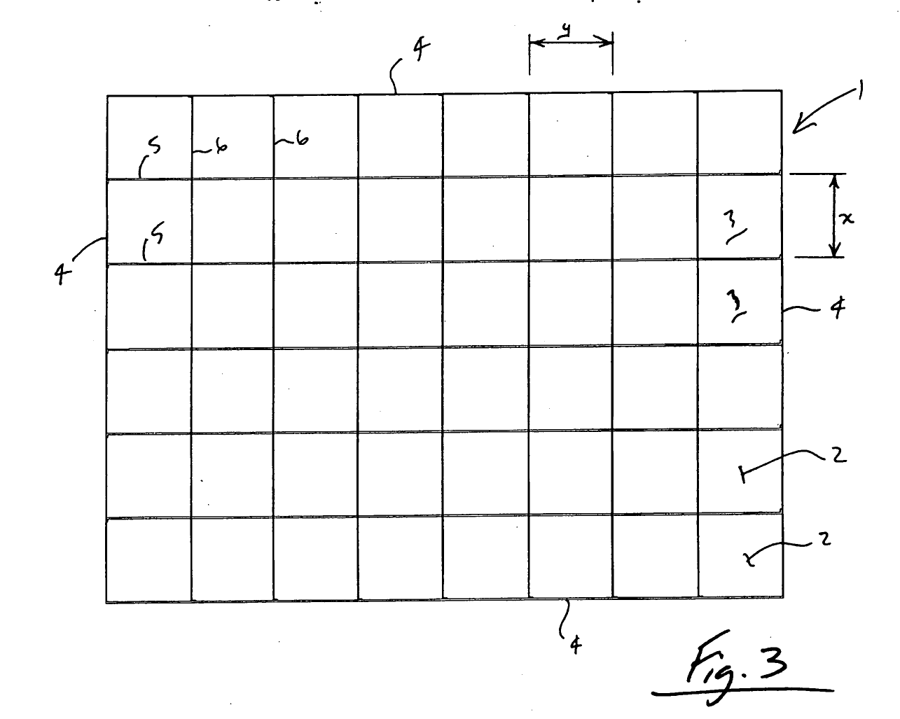

FIGS. 1 and 3 show one example of a keepsake niche housing for storing containers of partial cremation remains in a frame 1 that is rectangular with identical compartments 2 arranged in an array of rows and columns. It will be understood that various shapes of frames 1 can be constructed, such as cylindrical, wave formed, or multiple stepped shapes, without departing from the invention. Further the size and shape of compartments need not be cubic but may be rectangular, cylindrical, hexagonal or otherwise.

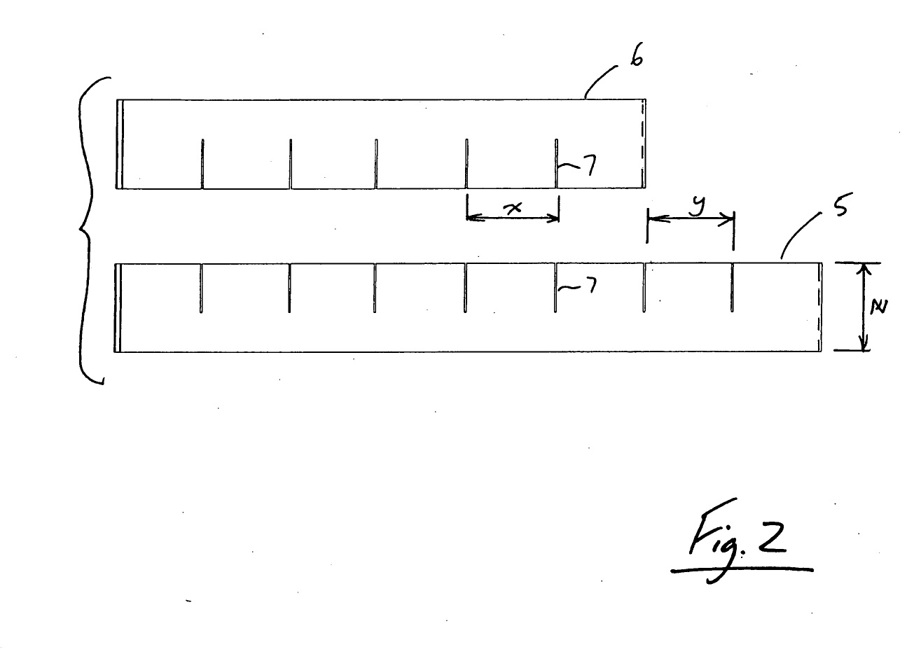

The illustrated compartments 2 each have an access opening 3 on one side and containment walls on all remaining sides defined by an exterior tray 4 with long and short divider plates 5, 6. The divider plates 5, 6 as shown in FIGS. 2-3 have bent ends to form a Z-shape which serves to support the divider plates 5, 6 within the exterior tray 4 during assembly. The slots 7 in divider plates 5, 6 interlock at right angles. The tray 4 and divider plates 5, 6 are shown in the example made of stainless sheet steel and are joined by spot welding for example. A suitable set of dimensions for each compartment 2 has been selected at no more than 4.5 inches for all interior dimension shown as “x”, “y”, and “z” in the drawings. However it will be understood that substantial modification of the dimensions and shape of the compartments 2 are within the scope of the invention.

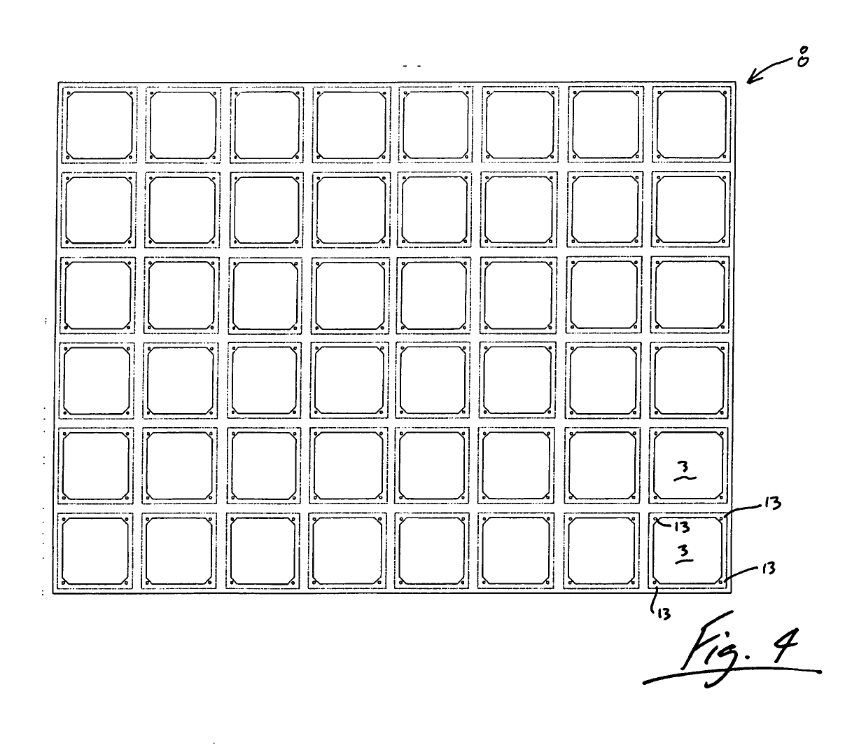

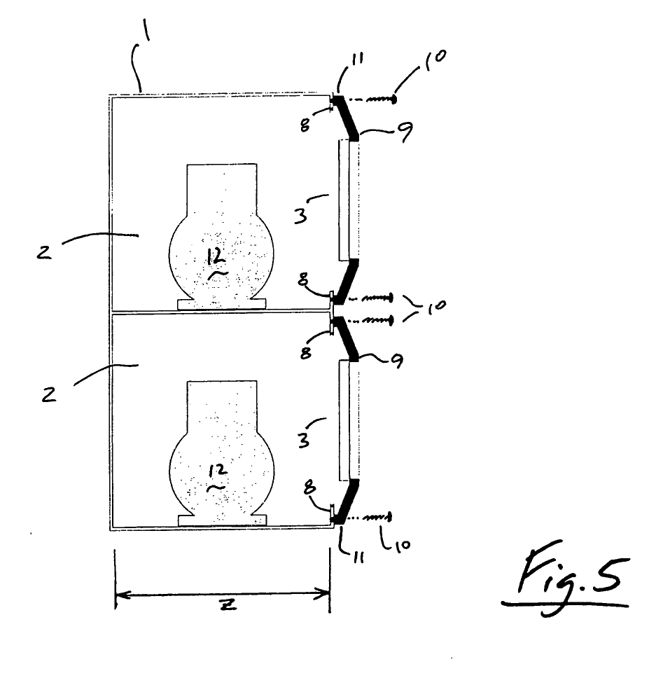

FIG. 4 shows the configuration of a cover plate 8, the outer surface of which provides a shutter mounting surface adjacent each access opening 3. As shown in FIG. 5, shutters 9 individually close the compartments 2 secured with removable tamper resistant fasteners 10 and optionally with a water resistant seal or gasket 11, when the containers 12 are installed. In FIG. 4, the four apertures 13 in the cover plate 8 are shown through which the fasteners 10 extend to secure the shutters 9. Preferably the frame 1 includes corner gusset plates (not shown) inward of each aperture 13 to secure the cover plate 8 to the frame 1 with fasteners 10 but without compromising the appearance of the cover plate 8 which may be polished metal or enamel coated metal for example.

The shutters 9 serve as memorial markers with indicia such as name, birth date, emblems, photographs or symbols.

Although the above description relates to a specific preferred embodiment as presently contemplated by the inventors, it will be understood that the invention in its broad aspect includes mechanical and functional equivalents of the elements described herein.

I claim:

1. A keepsake niche housing for storing a plurality of containers for partial cremation remains, the housing comprising:
a frame having a plurality of compartments, each compartment having containment walls and an access opening, a shutter mounting surface disposed adjacent each access opening; and
a plurality of removable shutters each adapted for individual mounting on each shutter mounting surface over each opening.

2. A housing according to claim 1 comprising a rectangular frame with identical compartments disposed in an array of rows and columns.

3. A housing according to claim 2 wherein the shutter mounting surfaces are coplanar.

4. A housing according to claim 3 comprising a cover plate defining each of the shutter mounting surfaces on a unitary plate surface.

5. A housing according to claim 4 wherein the plate includes apertures adapted for receiving removable threaded fasteners securing the removable shutters and the cover plate to the frame.

6. A housing according to claim 1 wherein the removable shutters include memorial indicia.

7. A housing according to claim 1 wherein each removable shutter includes at least one of: a water resistant seal; and a plurality of tamper resistant fasteners.

8. A housing according to claim 1 wherein the frame comprises an exterior tray with divider plates defining the compartments.

9. A housing according to claim 8 wherein the tray and divider plates are stainless steel.

10. A housing according to claim 1 wherein the compartments are cubic with interior dimension no greater than 4.5 inches.
